(19) United States
(12) Patent Application Publication
(10) Pub. No.: US 2016/0345702 A1
(43) Pub. Date: Dec. 1, 2016

(54) PERSONAL EFFECTS CARRIER WITH IMPROVED ZIPPER ENCLOSURE

(71) Applicant: WILLIAM ZAMORA, Homestead, FL (US)

(72) Inventor: WILLIAM ZAMORA, Homestead, FL (US)

(21) Appl. No.: 14/721,071

(22) Filed: May 26, 2015

(51) Int. Cl. A45C 15/06; A45C 13/10; H02J 7/00; A45C 3/06

(52) U.S. Cl. CPC A45C 15/06; A45C 3/06; A45C 13/103; H02J 7/0013

(57) ABSTRACT

A personal carry bag which includes one or more personal effects storage compartments, a battery pack, a zipper closure (having an electrically conductive zipper slide, for opening and closing a storage compartment associated with this bag), and multiple pairs of conductive contacts for completion of an electrical circuit between the battery pack and an accessory associated with each pair of conductive contacts. The relative position of electrically conductive zipper slide along the zipper closure, completes an electrical circuit between each contact pair, and thereby permits the accessory associated with the contact pair, to draw power from the battery pack, to an electrically powered accessory within the purse.

### BACKGROUND OF THE INVENTION

1. Field of the Invention

This invention relates to an article of manufacture. More specifically, this invention relates to a personal effects carrier (e.g. purse, brief case, fanny pack, backpack, etc.), having both an integrated power supply, battery powered accessories and a zipper closure, which can selectively activate one or more battery powered accessories, by changing the relative positions of a zipper slide/travel on the zipper closure.

2. Description of the Prior Art

The addition of battery powered accessories to a personal effects carriers is well-known. For example, battery powered lighting, as an accessory for women's handbags, has been disclosed in U.S. Pat. No. 3,609,341 (to Castaldo, issued September 28, 9, 9'71); U.S. Pat. No. 4,517,627 (to Bradford, issued May 14, 9, 9'85); U.S. Pat. No. 5,475,574 (to Chien, issued December 12, 9, 9'95); and U.S. Pat. No. 6,848,807 (to Guerrieri, issued February 1, 2005).

The Castaldo patent discloses a lady's handbag with a rotatable clasp style of closure for opening and locking the purse shut. In the closed position, the rotatable shaft of the clasp is in an electrically neutral, or in the “off” position. When the rotatable shaft is turned clockwise or counterclockwise, a camming knob on the shaft, also changes its relative from a neutral or “off” position, to a contact or “on”, position. In the “on” position, this knob on the shaft engages an electrical contact, and completes an electrical circuit, thereby causing light to go on within the purse. Depending upon the direction of rotation, an individual can selectively turn on lights in different compartments within the purse.

The Bradford patent discloses a flash lite mounted on an inside panel of a purse or handbag, wherein the mounting connection of the flash lite to the panel of the purse permits the flash lite to swivel or rotate on this connection, and thereby illuminate different areas within the purse while remaining mounted on the panel within the purse. Thus, the flash lite remains accessible at all times because it does no fall into the purse and comingle with the contents thereof.

The Chien patent discloses a carry bag with an electroluminescent strip integrated within the carry strap of the bag. The power supply for this electroluminescent strip is also integral with the strap. The strap is, thus, a complete and independent device, and can be readily transferred from one carry bag to another. The electroluminescent strip is controlled by a “function interface” (mini-computer, integrated circuit, etc.), which is pre-programmed to generate a variety of activation sequences, on/off, blinking, interval lighting, etc.

The Guerrieri patent discloses a portable light source which can be installed with a purse (FIG. 15) or in briefcase (FIG. 16). In each of the embodiments of the Guerrieri patent illustrated in these Figs, a magnetic closure or clasp is used to maintain the hand bag and brief case closed or associated with the mechanism which maintains the hand bag or brief case in the closed position. In the closed position, the electrical circuit between the power supply and an LED array is open or complete, and each of the LED lights on this electrical circuit thereby isolated from a source of power. Conversely, when the magnetic clasp on each of the hand bag and brief case is displaced, the field effect of this change in position of the magnetic closure or clasp, acts as switch to turn on the LED lights within the purse and the brief case. The subsequent reconnecting of the magnetic components of the clasp re-establishes the magnetic field, and interrupts the power supply to the LED lights, thereby earning them off when the purse and brief case are in the closed position.

The use of zipper slide/zipper track, (in combination), as a switch for completion of an electrical circuit is also well-known. For example, zipper switches for battery powered accessories associated with clothing, and for battery powered lighting in a lady's hand bag, has been disclosed in U.S. Pat. No. 6,801,140 (to Mantyljarvi et al. issued Oct. 5, 2004); and, US 2010/00328276 A1, (to Chen, published Feb. 8, 8′, 2010).

The Mantyljarvi et al patent discloses the incorporation of multiple digital devices within an article of “smart” clothing. The article of clothing Mantyljarvi et al has chosen to exemplify his invention is a jacket, having a zipper which runs the entire length of the front of the jacket from the collar to the belt line. The “smart” clothing has a plurality of digital devices embedded therein, each with its own power circuit, and a set of contacts embedded within, and at different locations, along the zipper track. Accordingly, as the wearer moves the zipper along the zipper track from one contact position to another, he completes a device specific electrical circuit, and thereby cause power to flow to one or more of the digital devices incorporated into the article of “smart” clothing (e.g. jacket).

The Chen publication discloses a lady's handbag with a zipper switch on a compartment within the hand bag. In Chen, the zipper switch is designed to complete an electrical circuit when the zipper slide, or traveler, moves from one end of the zipper track to the opposite end of the zipper track. It is this engagement of the zipper slide or traveler, with the zipper track stopper at the closed end of the track, which completes the electrical circuit and causes a light to go on within the zippered compartment.

In each of the above devices, the activation of an electrically powered device is accomplished by means of the change in position of a closure (switch), which in turn completes a circuit and causes power to flow to an electrically powered device. The use of a switch to turn on and off power in an electrical circuit is not new and the adaptation of this convention to zippers associated with items of apparel, and with carry bags for personal items is becoming more common, as demand for accessibility to personal electronic devise also increases. None of the devices discussed herein accomplish this integration of a power pack and an accessory in an acceptable manner in a personal carry bag for personal items. All such devices, with but one exception, are limited to their activation of a flash lite or LED array, in a personal carry bag or brief case. The effort at adaptation of a mobile power source, to selectively operate different mobile devices within personal apparel, is clumsy and fraught with problems, not the least of which being the incorporation of electrical contacts for the power circuit within a zipper track of the article of clothing. This latter suggestion produces both a mechanically fragile electrical circuit and a metal zipper track, and imprecise manipulation of the zipper to complete the electrical circuit. Accordingly, there continues to exist the need for a more robust electrical zipper switch, and the ability to operate such zipper switch without involving the zipper track, for completion of the electrical circuit.

### Objects of the Invention

It is the object of this invention to remedy the above as well as the related deficiencies in the prior art.

More specifically, it is the principle object of this invention to provide a personal carry bag having a zipper switch which permits the selective operation of a plurality of battery powered devices associated with the personal carry bag.

It is another object of this invention to provide a personal carry bag having a zipper switch wherein the relative movement of a zipper slide, along a zipper track, selectively activates a battery powered device by connection of such device to a source of electrical power within the carry bag.

It is still yet another object of this invention to provide a personal carry bag having a zipper switch wherein the relative movement of a zipper slide, along a zipper track, selectively inactivates activates a battery powered device.

Additional objects of this invention, include the use and adaptation of a zipper switch to (a) complete an electrical circuit from a power supply, within the personal carry bag, between a charging port on said carry bag, and an external power supply, to permit recharging of a battery pack; and/or a)) between the battery pack, within the personal carry bag, and a portable electronic device (e.g. cell phone), for recharging a portable electronic device.

### SUMMARY OF THE INVENTION

The above and related objects are achieved by providing a personal carry bag which includes a battery pack, with can include rechargeable batteries or some other electrical power reservoir. The zipper closure of the personal carry bag includes a pair of interlocking ribbons disposed in juxtaposition relative to one another along a zipper track. The interlocking ribbons comprise a ribbon of material (generally fabric), each ribbon having a linear array of complimentary teeth, positioned relative to one another in the zipper closure, for releasable engaging and disengaging as a zipper slide is moved along the zipper track. The fabric component of the interlocking ribbons comprises an insulating material, and the complementary fastening components, (teeth), can made from either a conductive or. In this embodiment of the invention, an electrically conductive zipper slide is provided for engaging and disengaging, each of said interlocking ribbons of the zipper closure with one another as the zipper slide is progressively moved along the zipper track, incident to opening and closing of the personal carry bag. Each member of the pair of the interlocking ribbons includes multiple contact pairs of discrete conductive contacts. These contacts are disposed along the electrically insulating material component of the interlocking ribbons, and are physically and electrically isolated one another, and thereby unable to complete an electrical circuit between the battery pack and an accessory associated each contact pair of conductive contacts. In the preferred embodiments of this invention, the circuit between the battery pack and a pair of conductive contacts is completed by movement of the conductive zipper slide along the zipper track, and thereby make physical contact with a contact pair on the interlocking ribbons, to complete an electrical circuit between the battery pack and an electrically powered accessory. Once such contact between the conductive zipper traveler and contact pair has been effected, power flows from the battery pack to an accessory associated with such contract pair. Conversely, when the physical contact between the conductive zipper traveler and contact pair, interrupted (by movement/re-positioning of the electrically conductive along the zipper track), the electrical connection the power supply to an accessory associates is interrupted, and the accessory turned off.

In an alternative embodiment of this invention, the completion of the circuit can include the activation of a timer associated within the electrical circuit between an accessory and a power supply. The timer, upon activation, permits a continuous flow of power through the contact pair, for a given interval, even after disengagement of the conductive zipper traveler and contact. In this alternative embodiment of the invention, the timer, upon activation, have its own independent connection to the battery pack, and thereby maintains the electrical connection between the activated accessory and the battery pack for a finite interval, after the zipper slide/traveler disengages the contact pair associated with accessory.

In another alternative embodiment of this invention, a separate and independent circuit is provide to manually energize an accessory. This manual operation is also zipper slide dependent and requires that the zipper slide of the zipper closure to be placed in a manual override position. Typically, the manual override position corresponds to the fully closed position of carry bag compartment. The manual control over the connection of the power supply to an accessory within the purse includes “kill switch.” to isolate the power supply within the purse.

### BRIEF DESCRIPTION OF DRAWINGS

FIG. 1 is a cross-section of a personal carry bag in the form of a lady's purse with a zipper closure for the opening and dosing the compartment which permits access to the contents of the purse.

FIG. 2 is an enlarge view of the zipper closure, in the open position, for the lady's purse of FIG. 1.

FIG. 3 depicts a typical electrical circuit, which includes a timer, for connecting an accessory to a power supply within a lady's purse.

### DETAILED DESCRIPTION OF THE INVENTION INCLUDING PREFERRED EMBODIMENT

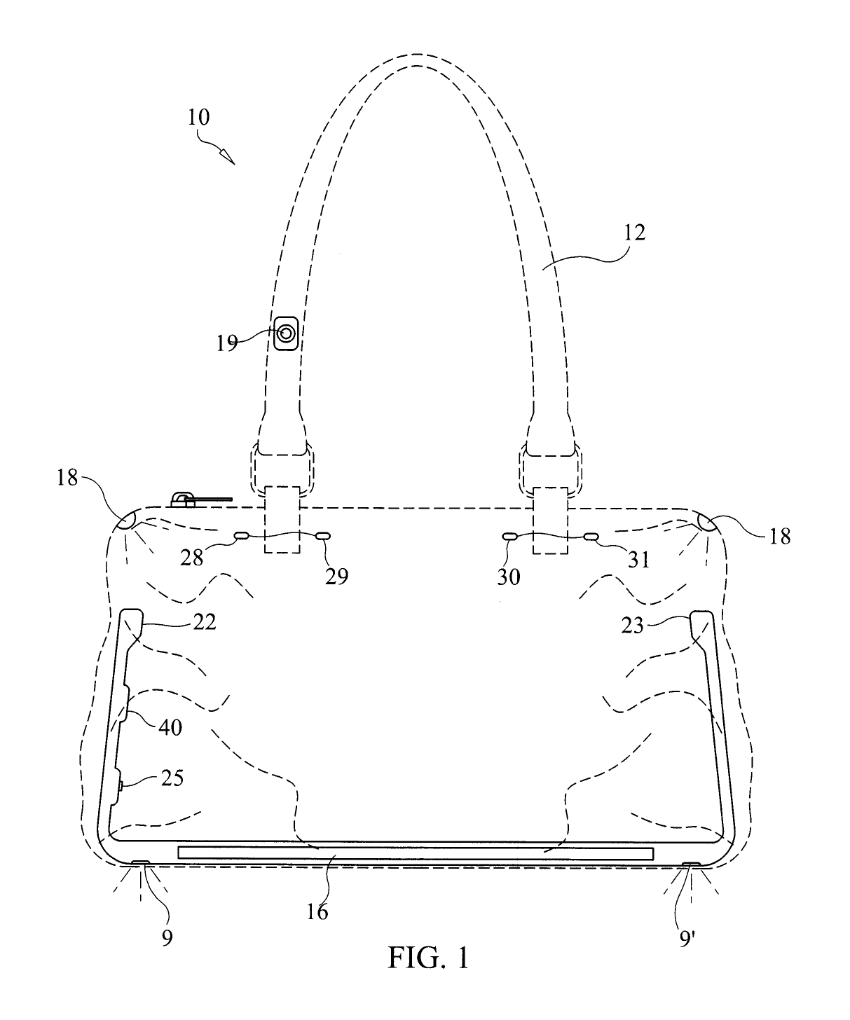

FIG. 1 depicts a cross-sectional view of personal carry bag in the form of a lady's purse (10). The purse (10) includes a hand strap (12), a zipper closure (14) and a battery pack (16), a an LED array (8, 8′) and an accessory port (20), for charging the battery pack (16) and a USB accessory port (22) for connection of portable electronic device (not shown) to the battery pack (16). Other accessories are depicted in FIG. 1, include a security locator (e.g. LoJack™), to permit recovery of the purse, if stolen. The purse depicted in FIG. 1, also provides for a manual switch (19) for activation of an accessory, and, alternative means, (e.g. kill switch) (5) for override of the manual switch and/or zipper switch, and thereby prevent any drain of power from the battery pack within the purse.

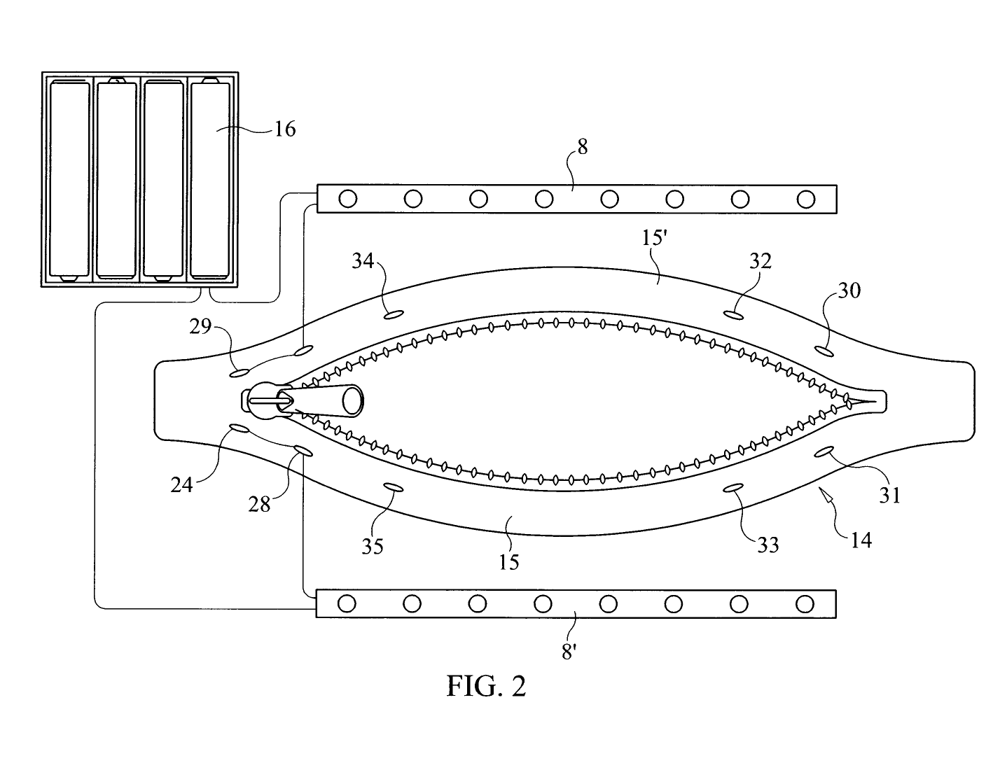

FIG. 2 depicts an enlarge view (from above) of zipper closure (14) of FIG. 1. In this FIG. 2, the zipper closure (14) is in the open position, and, thus, the zipper slide/traveler (24) is shown at one end of the zipper closure (14). In this open position, each member of a pair of interlocking ribbons (15, 15) are positioned in juxtaposition relative to one another along the zipper track (26). The movement of the zipper slide/traveler (24) from right to left, incident to opening the purse (16) has caused the pair of interlocking ribbons (15, 15) to disengage from one another, and thereby are depicted in spaced apart relationship from one another (unzipped). In this open (unzipped) position, the zipper slide (24) is shown to have physically engaged a pair of contacts (28, 29) at the zipper stop, and thereby completed an electrical circuit between a battery pack (16), and an LED array (8, 8′), within the purse.

FIG. 2 also illustrates multiple contact pairs (30, 31), (32, 33), (34, 35), positioned at regular intervals along the pair of interlocking ribbons (15, 15) of the zipper closure (14). Each contact pair is physically and electrically isolated from another by its location on each complementary ribbon component (36, 37) of the zipper track (26) of the zipper closure (14). In the operation of zipper closure (14) of this invention, the electrically conductive zipper slide/traveler (24) sequentially engages one or more of these contact pair as it moves along the zipper track (26). Thus, as the zipper closure (14) is progressively opened and closed. along the zipper track (26), an electrical circuit is opened and closed. When the electrically conductive zipper slide/traveler (24) physically engages the contact pair (28, 29) associated with the LED lighting array (8, 8′), the electrical circuit is completed between the contact pair (28, 29) and power supply (16), and the LED lighting array (8, 8′) is turned on within the purse (16).

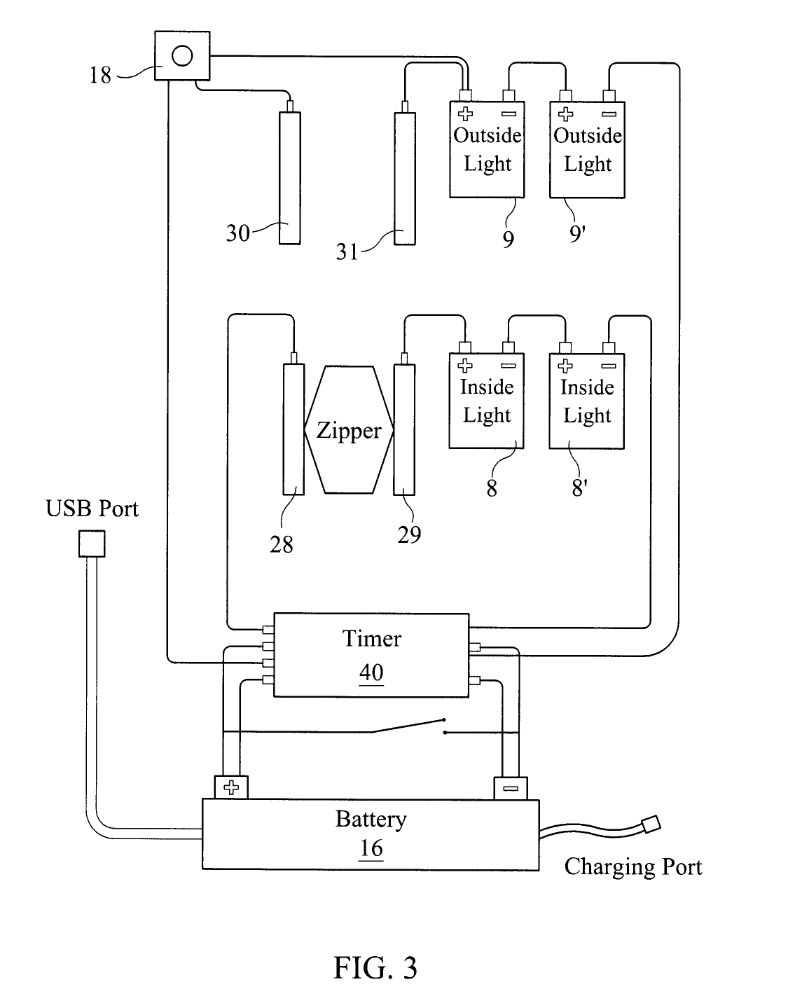

FIG. 3 depicts a representative embodiment of a typical circuit diagram of a power circuit within a lady's purse (10). In this FIG. 3, the power circuit illustrates the connection of more than one accessory (e.g. inside lights (8, 8′), outside lights (9, 9′)). by the zipper slide (24) of the zipper closure (14), to a power supply (16) within the purse (10). In this illustration, the zipper slide (24) is positioned along the zipper track (26), relative to a pair of contacts (28, 29), and thereby completes the electrical circuit between a battery (16) and the LED lighting array (8, 8′) within the purse. In this embodiment of the invention, a timer (40), within this circuit, is also activated upon completion of the circuit. The timer can be pre-programmed to “time out” at a pre-set interval and interrupt the circuit between the power supply (16) and the LED lighting array (8, 8′) within the purse, and thereby conserve battery power, and/or provide an alternative pathway for power to flow, for a pre-set interval, even after the zipper traveler has been moved and no longer is physical contact with the contacts. Thus, the timer (40) permits the zipper slide (24) to be re-positioned along the zipper track (26), to further open and/or close the purse without interruption of the power to the accessory (e.g. outside light). The timer (40), thus, limits the duration of the supply of power through the electrical connection between the power supply (16) and the LED lighting array (8, 8′) within the purse, to a finite, pre-programmed duration; and, alternatively, provides for continuation of connection of the power to the accessory, for a finite, pre-programmed duration when the zipper traveler is move from the corresponding accessory contacts. The timer can be a simply an integrated circuit, or similar electrical component, with a pre-programmed chip.

In the preferred embodiments of this invention, the configuration of the contract pair associated with a zipper closure (14) can vary depending upon the style of the personal carry bag; and/or a universal zipper closure having multiple contact pairs provided, much in the same way as a wiring harness is manufactured for use in an automotive environment, and thereafter the contact pairs of the universal zipper closure adapted to the battery location and menu of accessories for a personal carry bag.

What is claimed is:

1. In a personal carry bag haying battery pack and a zipper switch for connecting an electrically powered accessory to the battery pack with a zipper switch, the improvement comprising:
A. A zipper closure for a compartment of said personal carry bag,
a. said zipper closure having
i. A zipper track comprising a pair of interlocking ribbons disposed in juxtaposition relative to one another,
ii. Multiple contact pairs of discrete conductive contacts, one member of each such pair of said discrete contacts, being disposed in spaced apart relationship, relative to another member of a pair of said conductive contact, of one member of each of said pair of said interlocking ribbon,
iii. An electrically conductive zipper slide, for concurrently, sequentially engaging and disengaging each of said interlocking ribbons of said zipper closure, and each member of each pair of said conductive contacts, so as to effect
1. manipulating of said of interlocking ribbons of said zipper closure, relative to one another, to open and close said compartment, and
2. completing an electrical circuit between each member of said a pair of conductive contacts upon engagement of each of said interlocking ribbons with each other;
B. A battery pack in electrical contact with one member of a pair of a conductive contact; and
C. An electrical powered accessory in electrical contact with one member a pair of a conductive contact.
